(19) United States
(12) Patent Application Publication
(10) Pub. No.: US 2006/0008054 A1
(43) Pub. Date: Jan. 12, 2006

(54) Radiographic image capturing system and radiographic image capturing method

(76) Inventor: Hiromu Ohara, Tokyo (JP)

Correspondence Address: CANTOR COLBURN LLP, 55 Griffin Road South, Bloomfield, CT, 06002, US

(21) Appl. No.: 11/175,597

(22) Filed: Jul. 6, 2005

(30) Foreign Application Priority Data
Jul. 12, 2004 (JP) JP2004-204599

(51) Int. Cl. H05G 1/56

(52) U.S. Cl. 378/114

(57) ABSTRACT

A radiographing system for radiographing an object, has a radiation generator to irradiate radiation to an object, and a radiographic image detector to detect a radiographic image of the object. Each of the radiation generator and the radiographic image detector comprises a respective radio section to transmit and receive information as radio signals, and when radiographing the object, the radiation generator transmits irradiating information by a radio signal to the radiographic image detector, and then the radiographic image detector reads a radiographic image on a basis of the received the irradiating information.

This application is based on Japanese Patent Application No. JP2004-204599 filed on Jul. 12, 2004, in Japanese Patent Office, the entire content of which is hereby incorporated by reference.

### BACKGROUND OF THE INVENTION

The present invention relates to a radiographic image capturing system and radiographic image capturing method for detecting a radiographic image according to radiographic image capturing technology, using a radiographic image detector.

In the prior art, a radial ray from a radiation source of an X-ray, γ-ray or the like is applied to a subject such as a human body for medical examination to get a radiographic image in accordance with the transit dose of the subject. For example, an image capturing apparatus is well know in the art, wherein a wavelength conversion member such as a fluorescent screen is used to convert the wavelength to conform to a photosensitive wavelength range of a light receiving section in accordance with the transit dose of the subject. The result of conversion is further converted to an electric signal, whereby image information is obtained as electrical information (Patent Document 1). When configured in a flat panel similar to a radiographic image capturing cassette, this image capturing apparatus is also called a flat panel detector (FPD) as one type of a radiographic image detector.

The radiographic image information generated by the aforementioned FPD is transferred to a control apparatus composed of a personal computer (PC) or the like, where image processing is applied thereto. In the prior art, the FPD is connected with a control apparatus and X-ray source through a cable, and sends the signal indicating that the X-ray has been emitted from the X-ray source, using this cable. Based on this signal, the FPD reads the radiographic image. Further, as indicated in the Patent Document 2 given below, the X-ray is received by the FPD, and is used to start reading. If the FPD is provided with a switch, it can be operated to start reading subsequent to emission of the X-ray.

In a radiographic image detector such as an FPD, however, the electrical charge accumulated subsequent to emission of the X-ray is reduced by leakage with the lapse of time. To avoid this, the radiographic image is preferably scanned immediately after emission of the X-ray.

[Patent Document 1] Official Gazette of Japanese Patent Tokkaihei 11-345956

[Patent Document 2] Official Gazette of Japanese Patent Tokkai 2000-347330

### SUMMARY OF THE INVENTION

To solve the aforementioned problems involved in the prior art, it is an object of the present invention to provide a radiographic image capturing system and a radiographic image capturing method capable of reading a radiographic image with a radiographic image detector immediately after the radiographic image has been captured.

The above object can be attained by the following structure.

A radiographing system for radiographing an object, comprising:

(1) a radiation generator to irradiate radiation to an object, and

(2) a radiation image detector to detect a radiation image of the object,

wherein each of the radiation generator and the radiation image detector comprises a respective radio section to transmit and receive information as radio signals, and

wherein when radiographing the object, the radiation generator transmits irradiating information by a radio signal to the radiation image detector, and then the radiation image detector reads a radiation image on a basis of the received the irradiating information.

### BRIEF DESCRIPTION OF THE DRAWINGS

FIG. 1 is a diagram schematically representing a radiographic image capturing system for capturing a radiographic image of a patient, thereby getting the radiographic image thereof in the present embodiment;

FIG. 2 is a perspective view partially cut away to show the interior of the radiographic image detector of FIG. 1;

FIG. 3 is a circuit structure of the radiographic image detector of FIG. 2;

FIG. 4 is a partial cross sectional view of an image capturing panel 21 of FIG. 2;

FIG. 5 is a block diagram schematically showing the radiographic image capturing system of FIG. 1;

FIG. 6 is a flowchart representing the Steps S01 through S13 in a radiographic image capturing method used in the radiographic image capturing system of FIG. 1;

FIG. 7 is a flowchart representing the Steps S21 through S33 in another radiographic image capturing method used in the radiographic image capturing system of FIG. 1;

FIG. 8 is a circuit structure of a radiographic image detector composed of an image capturing panel containing a photoelectric conversion device using an organic substance; and

FIG. 9 is a partial cross sectional view showing the image capturing panel of FIG. 8.

### DETAILED DESCRIPTION OF THE PREFERRED EMBODIMENT

Firstly, preferable structure to attain the above object will be describe.

To achieve the aforementioned object, the present invention provides a radiographic image capturing system comprising:

a radiation generation apparatus for applying radial rays to a subject; and

a radiographic image detector for detecting the radiographic image through application of radial rays to the aforementioned subject;

wherein the timing information indicating the initiation and termination of radiation exposure is sent to the radiographic image detector from the radiation generation apparatus by radio, and the radiographic image is scanned by the radiographic image detector according to this timing information.

According to this radiographic image capturing system, the radiographic image is scanned by the radiographic image detector according to this timing information indicating the initiation and termination of radiation exposure, this information having been sent to the radiographic image detector from the radiation generation apparatus by radio. This arrangement enables the radiographic image detector to scan the radiographic image immediately after the radiographic image has been captured. Accordingly, this arrangement is preferred because it allows the radiographic image detector such as an FPD to scan the radiographic image before the electrical charge accumulated subsequent to application of radial rays is reduced by leakage or other reasons.

The radiographic image capturing system further comprises a control apparatus which is connected with the aforementioned radiation generation apparatus, and further with the radiographic image detector by radio, wherein the timing information is sent to the radiographic image detector through the control apparatus.

The radiation generation apparatus and radiographic image detector each are preferably provided with a radio communication section.

The aforementioned timing information is generated according to the,irradiation signal when radial rays are applied by of the radiation generation apparatus.

The radiation generation apparatus is preferably equipped with a means for generating an irradiation ready signal prior to the irradiation signal. In this case, the radiographic image detector performs a reset operation based on the irradiation ready signal having been received. This arrangement allows the radiographic image detector to be reset immediately before radiation exposure. Upon completion of the reset operation, a message is preferably indicated on the radiation generation apparatus to show that the system is enabled to capture a radiographic image.

The radiographic image detector scans radiographic image after the lapse of a predetermined time upon receipt of an irradiation start signal. This configuration provides easy control in such a way as to scan the radiographic image immediately upon completion of application of radial rays.

In the radiographic image capturing method of the present invention, the radiation generation apparatus applies radial rays to a subject, and the radiographic image detector detects the radiographic image of the subject captured by radiation exposure. This method comprises a step of sending the timing information from the radiation generation apparatus to the radiographic image detector by radio, wherein this timing information indicates the initiation and termination of radiation exposure; and a step of the radiographic image detector reading the radiographic image based on the timing information.

According to this radiographic image capturing method, the radiographic image is scanned by the radiographic image detector according to the timing information indicating the initiation and termination of radiation exposure, where this information has been sent thereto from the radiation generation apparatus by radio. This arrangement enables the radiographic image detector to scan the radiographic image immediately after the radiographic image has been captured. Accordingly, it allows the radiographic image detector such as an FPD to scan the radiographic image before the electrical charge accumulated subsequent to application of radial rays is reduced by leakage or other reasons.

In the aforementioned radiographic image capturing method, the control apparatus is preferably connected with the aforementioned radiation generation apparatus, and further with the radiographic image detector by radio, wherein the timing information is sent to the radiographic image detector through the control apparatus.

The aforementioned timing information is preferably generated according to the irradiation signal when radial rays are applied by the radiation generation apparatus.

The radiation generation apparatus preferably generates an irradiation ready signal prior to the irradiation signal. In this case, the radiographic image detector performs a reset operation based on the irradiation ready signal having been received. This arrangement preferably allows the radiographic image detector to be reset immediately before radiation exposure. Upon completion of the reset operation, a message is preferably indicated on the radiation generation apparatus to show that the system is enabled to capture a radiographic image.

The radiographic image detector scans radiographic image after the lapse of a predetermined time upon receipt of an irradiation start signal. This configuration provides easy control in such a way as to scan the radiographic image immediately upon completion of application of radial rays.

The radiographic image capturing system and radiographic image capturing method according to the present invention enables the radiographic image detector to scan the radiographic image immediately after the radiographic image has been captured.

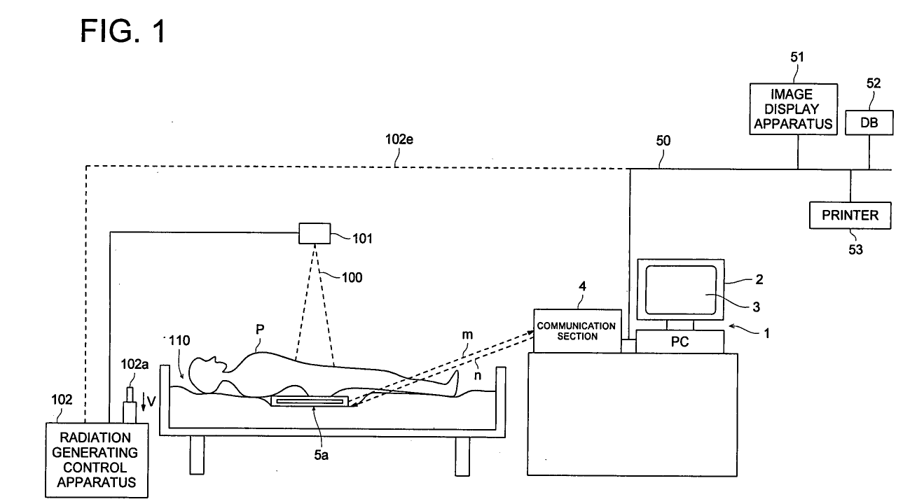

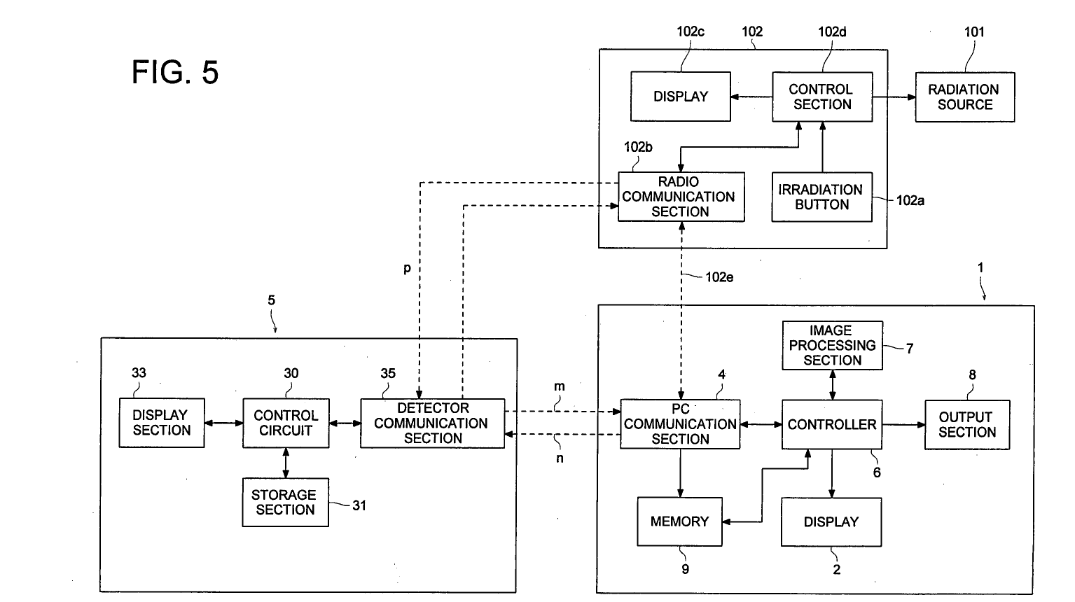

Referring to drawings, the following describes the best form of embodiment of the present invention. FIG. 1 is a diagram schematically representing a radiographic image capturing system for capturing a radiographic image of a patient, thereby getting the radiographic image thereof in the present embodiment. FIG. 5 is a block diagram schematically showing the radiographic image capturing system of FIG. 1.

In the radiographic image capturing system of FIG. 1, a radial ray 100 (X-ray) is applied to a subject to be radiographed in the lying position on a bed 110 to a subject to be radiographed in the lying position on the bed 110. The radial ray in response to the dose of the radiation having passed through site of the patient P to be radiographed is detected by a flat panel-like radiographic image detector 5 arranged in such a way as to be sandwiched between the bed 110 and patient P.

A stationary or rotary anode X-ray tube is commonly used as the radiation source 101. The X-ray tube is considered to have a voltage of 20 kV through 150 kV, for example, when the negative voltage of the anode is for medical treatment. As shown in FIG. 5, when an irradiation signal has been produced by depressing an irradiation button 102a, the radiation source 101 emits radial rays under control of the control section 102d.

As shown in FIGS. 1 and 5, a radiographic image detector 5 generates the radiation image data based on the result of detection of the transmission radial rays, and stores it in a storage section 31. It also sends the generated radiation image data as a data radio signal m by radio waves to the control apparatus 1 as a transfer destination from a detector communication section 35.

In the control apparatus 1, as shown in FIGS. 1 and 5, the data radio signal m of the radiographic image data from the radiographic image detector 5 is received by a PC communication section 4 and the radiographic image is indicated on the screen 3 of a display section 2. An image processing section 7 applies image processing such as frequency processing and gradation processing, and the radiographic image data subsequent to image processing is stored in a storage section 9. It is outputted from an output section 8 to the image display apparatus of a consultation room, a database server and a printer. As shown in FIG. 5, the control apparatus 1 can send the radio signal n from the PC communication section 4 to the detector communication section 35 of the radiographic image detector 5. The control apparatus 1 is installed outside the radiographing room and the PC communication section 4 is mounted in the radiographing room.

As shown in FIGS. 1 and 5, the radiation generation control apparatus 102 is composed of an irradiation button 102a, radio communication section 102b, display section 102c and control section 102d. When the irradiation button 102a has been depressed in the first stage in the downward direction v of FIG. 1, the irradiation ready signal is generated to show that it is the timing information for indicating the initiation of irradiation. Then when the irradiation button 102a is depressed in the second stage in the downward direction v of FIG. 1, an irradiation signal occurs. Generation of this irradiation signal causes radial rays to be emitted from the radiation source 101. Emission of radial rays from the radiation source 101 terminates in a very short time. The irradiation signal represents the timing information for indicating the termination of irradiation.

The irradiation ready signal and irradiation signal from the irradiation button 102a is sent from the radio communication section 102b to the detector communication section 35 of the radiographic image detector 5 as a radio signal p under control of the control section 102d. When the irradiation ready signal has been sent from the radiation generation control apparatus 102, it is received by the detector communication section 35 of the radiographic image detector 5. This process allows the radiographic image detector 5 to be reset. When the irradiation signal is sent, the radiographic image detector 5 scans the image data.

Upon completion of the reset operation of the radiographic image detector 5, a reset completion signal is sent from the detector communication section 35 to the radio communication section 102b of the radiation generation control apparatus 102 as a radio signal r. Then the control section 102d of the radiation generation control apparatus 102 allows the display section 102c to indicate a message for showing that the system is enabled to capture a radiographic image.

As described above, communication between the radiation generation control apparatus 102 and radiographic image detector 5 is carried out by radio. As compared to the case of using a wired means, there is no need of preparing a special connection cable, and preparation work for capturing a radiographic image is simplified. In addition to radio communication, optical communication using infrared rays or the like may be adopted.

The control apparatus 1 shown in FIGS. 1 and 5 is composed of a personal computer, and is equipped with a computer proper (PC), and an input apparatus (not illustrated) including such a pointing device as a mouse, a keyboard and the like, in addition to a display section 2 composed of a liquid crystal display, CRT or the like. As shown in FIG. 5, the control apparatus 1 is connected to an image display apparatus 51 a database server 52 and a printer 53 in the consultation room via a network 50, so that radiographic image data can be transferred.

As described above, the radiographic image capturing system of FIG. 1 allows the radiographic image detector 5 to generate and detect the radiographic image of the patient P and to transfer it to the control apparatus 1. After checking and processing the image, the control apparatus 1 converts it into a form that can be diagnosed. Then this radiographic image can be outputted or saved.

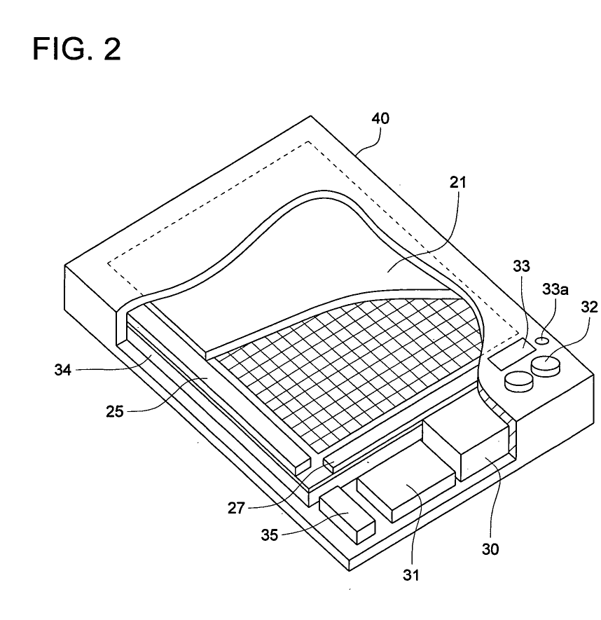

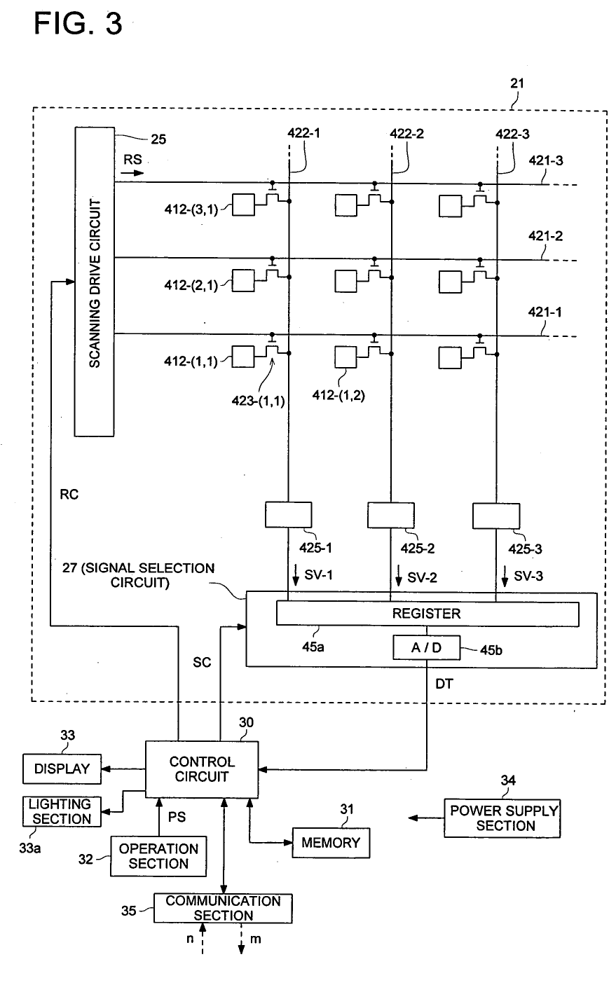

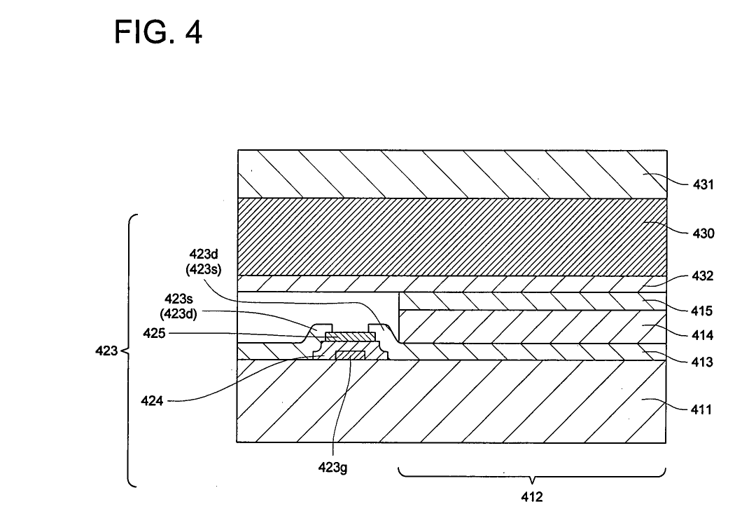

The following describes the aforementioned radiographic image detector 5 of FIG. 1 with reference to FIGS. 2 through 4. FIG. 2 is a perspective view-partially cut away to show the interior of the radiographic image detector of FIG. 1. FIG. 3 is a diagram representing the circuit configuration of the radiographic image detector of FIG. 2. FIG. 4 is a partial cross sectional view representing an image capturing panel of FIG. 2.

Radiographic image detector 5 is an FPD (flat panel detector) which is structured to be portable and flat-panel shaped, and constitutes a radiographic image acquisition apparatus. The following describes this detector with reference to the configuration example previously disclosed by the present inventor in Japanese Patent Tokkai 2000-250152.

As shown in FIG. 2, radiographic image detector 5 is composed of image capturing panel 21, control circuit 30 for controlling the operation of radiographic image detector 5, memory 31 for storing the image signal outputted from image capturing panel 21 using the rewritable read-only memory such as a flash memory or others, power supply section 34 for supplying power required to get the image signal by driving image capturing panel 21, and detector communication section 35 for radio communication between radiographic image detector 5 and PC communication section 4 of FIG. 1. These devices are incorporated in flat rectangular casing 40.

As shown in FIG. 2, the outer surface of casing 40 is provided with operation section 32 for switching the operation of the radiographic image detector 5, display section 33 for indicating the termination of preparation for capturing a radiographic image and completion of writing a predetermined amount of image signals into memory 31, and for displaying the patient information such as patient name and lighting section 33a composed of an light-emitting diode.

As shown in FIG. 3, image capturing panel 21 is composed of reading drive circuit 25 for reading out the stored electric energy in response to the intensity of the radiation applied, and signal selecting circuit 27 for outputting the stored electrical energy as an image signal.

It is preferable that casing 40 is made of a material which can resist impact from the outside and is light to the utmost, namely of a material of aluminum or its alloy. The side of the casing through which radiation enters is structured by using a nonmetal which easily transmits the radiation, namely by using, for example, carbon fibers. In the case of the back side that is opposite to the side of the casing through which the radiation enters, it is preferable that a material that absorbs radiation effectively, namely, a lead plate is used, for preventing that radiation passes through radiation image detector 5, or for preventing an influence from the second-order radiation that is caused when a material constituting the radiation image detector 5 absorbs radiation.

In casing 40, reading drive circuit 25, signal selecting circuit27, control circuit 30 and memory 31 and the like are covered with radiation shielding member (no illustration) to prevent scattering of radiation and irradiation of radiation to each circuit inside casing 40. Power supply section 34 may be a primary cell such as a manganese battery, a nickel-cadmium battery, a mercury battery or a lead battery, or a secondary cell which is rechargeable such as a nickel-polymer secondary battery or a lithium-ion-polymer battery. It is preferable that the battery is a plate-shaped to make an FPD thinner.

As shown in FIG. 3, in image capturing panel 21, photoelectric transduction element 412-(1,1) to 412-(m,n) which detect visible light converted by a scintillator and photoelectrically transduce the visible light into image signals carrying radiographic image of a subject are located two dimensionally. Between photoelectric transduction elements 412, reading lines 421-1 to 421-m and signal lines 422-1 to 422-n are located to cross perpendicularly each other. photoelectric transduction element 412-(1,1) is connected to one transistor 423-(1,1). A field effect transistor is employed for transistor 423-(1,1) and a drain electrode and a source electrode are connected to photoelectric transduction elements 412-(1,1) while a gate electrode is connected to reading lines 421-1. When the drain electrode is connected to photoelectric transduction elements 412-(1,1), the source electrode is connected to signal lines 422-1 and when the source electrode is connected to photoelectric transduction elements 412-(1,1), the drain electrode is connected to signal line 422-1. One image is formed by this means.

Other photoelectric transduction elements 412 are connected to transistor 423 and signal lines 422 are connected to source electrodes or drain electrodes while gate electrodes of transistor 423 are connected to reading lines 421.

As shown in FIG. 4, photoelectric transduction element 412 is composed of a photodiode including signal line 413 formed of pattern-molded conducting film on substrate 411, amorphous-silicon layer 414 and transparent electrode 415. signal line 413 is connected to drain electrode 423d (or source electrode 423s) of thin film transistor 423 formed on substrate 411. Gate electrode 423g of thin film transistor 423 is connected to a reading line and source electrode 423s (or drain electrode 423d) is connected to signal line 422. Further, gate insulating layer 424 and semiconducting layer 425 are installed between source electrode 423s or drain electrode 423d and gate electrode 423g.

On photoelectric transduction element 412, phosphor layer (scintillating layer) 430 is formed, and base 431 is installed on the back (X-ray source side) in some cases. On the surface of phosphor layer 430, protective layer 432 is formed as to be described later and when phosphor layer 430 is laid on photoelectric transduction elements 412, protective layer 432 is included between photoelectric transduction elements 412 and phosphor layer 430.

As shown in FIG. 3, reading lines 421-1 to 421-m on image capturing panel 21 are connected to reading drive circuit 25 and signal lines 422-1 to 422-m are connected to electric charge detectors 425-1 to 425-n. When charge read-out signal RS is provided to reading line 421-p which is one among reading lines 421-1 to 421-m (“p” is any one between “1” to “m”) from reading drive circuit 25, transistor 423-(p, 1) to 423-(p, n) connected to reading line 421-p become “on” state and signal charge generated in photoelectric transduction elements 412-(p, 1) to 412-(p, n) is provided to electric charge detectors 425-1 to 425-n through signal lines 422-1 to 422-n. In electric charge detectors 425-1 to 425-n, voltage signals SV-1 to SV-n are generated, which are proportional to the charge amount provided through signal lines 422-1 to 422-n. Voltage signals SV-1 to SV-n outputted from electric charge detector 425-1 to 425-n are provided to signal selecting circuit 27.

Signal selecting circuit 27 is composed of a register 45a and A/D converter 45b. Voltage signal is supplied to the register 45a from electrical charge detectors 425-1 through 425-n. Register 45a sequentially selects the supplied voltage signals, which are converted into the digital data by A/D converter 45b. This data is supplied to control circuit 30.

Control circuit 30 generates a reading control signal RC and output control signal SC, based on the control signal CTD contained in the radio signal “n” received from the controlling apparatus 1 (FIG. 1) through detector communication section 35. This reading control signal RC is supplied to reading drive circuit 25, and electric charge readout signal RS is supplied to reading lines 421-1 through 421-m, based on the reading control signal RC. Further, the output control signal SC is supplied to signal selecting circuit 27, and selection of the voltage signal from electrical charge detectors 425-1 through 425-n stored in register 45a is controlled. At the same time, the selected voltage signal is converted into the data signal and is supplied as the image data DT to control circuit 30 from signal selecting circuit 27.

Control circuit 30 sends the image data DT as a radio signal “m” to the controlling apparatus 1 (FIG. 1) through communication section 35. If the image data are subjected to logarithmic transformation when the image data DT are sent to controlling apparatus 1, the processing of image data in controlling apparatus 1 is simplified. Further, the aforementioned logarithmic transformation can be performed simultaneously as the read-out electric charge is converted into voltage signal SV by electrical charge detectors 425. When the digital data is obtained by A/D converter 45b in this manner subsequent to logarithmic transformation, it is possible to improve the resolution of radiographic information in areas with small voltage signal SV.

The phosphor layer 430 of image capturing panel 21 of FIG. 4 is produced in the following manner. The phosphor paint consisting of a phosphor and a binder is applied on a support member to form a phosphor layer. After that, the phosphor layer is directly placed on the photoelectric transduction element, and is bonded thereon. It is also possible to take the following procedures. A phosphor paint is coated on a temporary support member, and is then dried and separated from the support member, whereby a sheet-shaped phosphor layer is formed, and is bonded. Alternatively, the phosphor paint is sprayed to form a phosphor layer or the phosphor paint is coated on the photoelectric transduction element directly or through a protective layer.

To form this phosphor layer 430, a bond and a phosphor are added into the adequate organic solvent, which is stirred and mixed using a disperser and a ball mill, thereby preparing phosphor paint wherein the phosphor is uniformly dispersed in the bond.

As phosphors, preferably employed are a tungstate phosphor (CaWO₄, MgWO or CaWO₄:Pb), a terbium activated rare earth sulfide phosphor (Y₂O₂S:Tb, Gd₂O₂S:Tb, La₂O₂S:Tb, (Y, Gd)₂O₂S:Tb or (Y, Gd)O₂S:Tb, Tm), a terbium activated rare earth phosphate phosphor (YPO₄:Tb, GdPO₄:Tb or LaPO₄:Tb), a terbium activated rare earth oxyhalide phosphor (LaOBr:Tb, LaOBr:Tb, Tm, LaOC1:Tb, LaOC1:Tb, Tm, LaOBr:Tb, GdOBr:Tb, GdOC1:Tb), a thulium activated rare earth oxyhalide phosphor (LaOBr:Tm or LaOC1:Tm), a barium sulphate phosphor (BaSO₄:Pb, BaSO₄:Eu²⁺ or (Ba, Sr) SO₄:Eu²⁺), an europium activated alkali earth metal phosphate phosphor (Ba₂(PO₄)₂:Eu²⁺, (Ba₂PO₄)₂:Eu²⁺), an europium (II) activated alkali earth metal fluoride halide phosphor (BaFC1:Eu²⁺, BaFBr:Eu²⁺, BaFC1:Eu²⁺, Tb, BaFBr:Eu²⁺, Tb, BaF₂BaC1.KC1:Eu²⁺ or (Ba, Mg) F₂.BaC1.KC1:Eu²⁺, an iodide phosphor (CsI:Na, CsI:T1, NaI or KI:T1), a sulfide phosphor (ZnS:Ag, (Zn, Cd) S:Ag, (Zn, Cd) S:Cu or (Zn, Cd) S:Cu, Al), a hafnium phosphate phosphor (HfP₂O₇:Cu), a tantalate phosphor (YTaO₄, YTaO₄:Tm, YTaO₄:Nb, (Y, Sr) TaO₄₋ₓ:Nb, LuTaO₄, LuTaO₄:Nb, (Lu, Sr) TaO₄₋ₓNb, GdTaO₄:Tm or Gd₂O₃.Ta₂O₅.B₂O₃:Tb) and especially Gd₂O₂S:Tb or CsI:T1 is preferable.

Without being restricted to the aforementioned type, the phosphor can be of any type, provided that it allows light to be emitted in the visible area upon radiation exposure and the photoelectric transduction element is sensitive to the wavelength of this emitted light.

Here the average grain diameter of the phosphor is 0.5 μm or more without exceeding 10 μm, preferably 1 μm or more without exceeding 5 μm in such a way that the filling factor of the phosphor in the phosphor layer is increased, high-definition light emission is achieved, and the scattering of light emitted from the phosphor in the phosphor layer is reduced.

The solvent for preparing the phosphor paint includes a lower alcohol such as methanol, ethanol, n-propanol and n-butanol; hydrocarbon containing chlorine atoms such as methylene chloride and ethylene chloride; a ketone such as acetone, methyl ethyl ketone and methyl isobutylene ketone; an aromatic compound such as toluene, benzene, cyclohexane, cyclohexanon and xylene; an ester of lower fatty acid and lower alcohol such as methyl acetate, ethyl acetate and butyl acetate; ether such as dioxane, ethylene glycol monoethyl ester and ethylene glycol monomethyl ester; and mixtures thereof.

The phosphor paint may be mixed with various forms of additives such as dispersant for improving the dispersion properties of the phosphor in the paint, or the plasticizer for improving bondage between the binder and the phosphor in the phosphor layer having been formed.

The dispersant can be exemplified by phthalic acid, strearic acid, caproic acid and lipophilic surface active agent. The plasticizer is exemplified by a phosphoric ester such as triphenyl phosphate, tricresyl phosphate, diphenyl phosphate; a phthalic ester such as diethyl phthalate and dimethoxy ethyl phthalate; a glycolic ester such as ethyl phthalyl ethyl glycolate and butyl phthalyl butyl glycolate; polyethylene glycol such as polyester of triethylene glycol and adipic acid, and polyester of diethylene glycol and succinic acid; and polyester with aliphatic diacid.

The phosphor paint containing the phosphor and binder adjusted in the aforementioned manner is uniformly coated over the surface of the support member or the temporary support member for sheet formation, whereby a coating film of paint is formed.

The thickness of phosphor layer 430 is preferably 20 μm through 150 μm, and more preferably 20 μm through 100 μm in order to get a sufficient amount of photo-stimulated luminescence and to minimize scattering of light in the phosphor layer.

The coating means which can be utilized includes a doctor blade, a roll coater, a knife coater and an extrusion coater.

Support member 431 of FIG. 4 can be made of various types of material such as glass, wool, cotton, paper and metal. For the sake of handling as an information recording material, support member 431 is preferably made of a material which can be formed into a flexible sheet or a roll. In this respect, particularly preferred materials are a plastic film such as a cellulose acetate film, polyester film, polyethylene terephthalate film, polyamide film, polyimide film, triacetate film and polycarbonate film; a metallic sheet such as aluminum foil and aluminum alloy foil; general paper or a basis paper for printing such as basis paper for photograph like coated paper or art paper, baryta paper, resin coated paper, a paper sized with polysaccharide disclosed in the Specification of the Belgium Patent No. 784,615; pigment paper containing pigment such as titanium dioxide; and converted paper such as paper sized with polyvinyl alcohol.

To improve the bondage between support member 431 and phosphor layer 430, a high molecular substance such as polyester or gelatine can be coated on the support surface, thereby providing an undercoated layer for enhanced adhesiveness. Further, to improve the image quality (sharpness and granularity), a light absorbing layer composed of a light absorbing material such as carbon black can be provided, thereby absorbing at least a part of the light emitted from the scintillator. The configuration thereof can be selected freely in response to particular purposes and uses. A support member made of black polyethylene terephthalate containing carbon black is preferably used.

Phosphor layer 430 is provided with protective layer 432 for physical and chemical protection of the surface opposite to the surface in contact with support member 431. Protective layer 432 can be formed by coating the surface of the phosphor layer with the solution prepared by solving a cellulose derivative or synthetic high molecular substance into a proper solvent, wherein the aforementioned cellulose derivative includes cellulose acetate and nitrocellulose, and the molecular substance includes polymethyl methacrylate, polyethylene terephthalate, polyvinyl butyral, polyvinyl formal, polycarbonate, polyvinyl acetate, polyvinyl chloride and vinyl acetate copolymer. Such a high-molecular substance can be used independently or in combination. A crosslinking agent is preferably added immediately before coating protective layer 432. Alternatively, adhesive is used to bond a plastic sheet composed of polyethylene terephthalate, polyethylene naphthalate, polyethylene, polyvinylidene chloride or polyamide, thereby forming protective layer 432.

The protective layer is preferably formed by the coated film containing a fluorine-based resin soluble in an organic solvent. The fluorine-based resin in which it is used here refers to the compound of olefin containing fluorine (fluoro-olefin) or the copolymer including fluorine-containing olefin as a copolymer component. The protective layer formed by the coated film of fluorine-based resin may be crosslinked. To improve the film strength, the fluorine-based resin may be mixed with other high-molecular substances.

The aforementioned protective layer 432 preferably has a thickness of 0.5 μm or more without exceeding 10 μm or more preferably 1 μm or more without exceeding 3 μm. Use of such thin protective layer 432 reduces the space between phosphor layer 430 and photoelectric transduction element, and therefore, the light emitted from phosphor layer 430 directly enters the photoelectric transduction element, without being scattered by protective layer 432. This arrangement improves the sharpness of the radiographic image.

Then at least one of phosphor layer 430 and protective layer 432 is colored to reduce possible deterioration of sharpness resulting from scattering of the light by the phosphor inside the phosphor layer. The coloring agent preferably used is a blue or red one that absorbs at least some part of the light in the range of light emitting wavelength of the phosphor.

For example, the yellow or red coloring agent (dyestuff or pigment) used in the phosphor for emitting light in the green range includes various dyes such as an azo dye, acridine dye, quinoline dye, thiazole dye and nitro dye; and various pigments such as molybdenum orange, cadmium yellow, chrome yellow, zinc chromate, cadmium yellow and red lead. The content of the coloring agent is generally determined by selection from the range 10:1 through 10⁶:1 (phosphor:coloring agent, in terms of weight ratio) when the coloring agent is a dye, although it may differ according to the intended use of the phosphor layer, the portion to be colored and type of the coloring agent. When the coloring agent is a pigment, selection is made from the range 1:10 through 10⁵:1 (phosphor:coloring agent, in terms of weight ratio).

When using a phosphor for emitting light in the green range, coloring may be done by a coloring agent having the main peak of absorption spectrum in the wavelength of 420 nm through 540 nm. Further, coloring may also be done by a coloring agent wherein the average absorbency index in the light emitting range with a wavelength greater than the peak wavelength of the light emitted by the phosphor is higher than the average absorbency index in the light emitting area with a wavelength smaller than the peak wavelength.

In the above description, a phosphor layer is formed by uniform coating of the support member with phosphor paint. It can also be formed by vapor deposition method, for example. If this phosphor layer is designed in a colum crystal structure, scattering of light emitted by the phosphor in the phosphor layer can be reduced by the optical guide effect.

As shown in FIG. 3, control circuit 30 is connected with memory 31, operation section 32, display section 33 and communication section 35. The operation of radiographic image detector 5 is controlled according to the operation signal PS from operation section 32 or the radio signal “n” from controlling apparatus 1.

Operation section 32 is provided with a plurality of switches. Initialization of image capturing panel 21 and generation of the radiographic image signal are carried out according to operation signal PS in response to the switching operation from operation section 32 or the radio signal “n” from controlling apparatus 1. The storage capacity of memory. 31 is sufficient to store a plurality of pieces of image data.

Control circuit 30 provides processing of allowing the generated image signal to be stored in the memory 31. It also transfers the data radio signal “m” by radio from detector communication section 35 to PC communication section 4 shown in FIGS. 1 and 5.

As described above, radiographic image detector 5 shown in FIGS. 2 through 4 is designed in a portable flat panel structure with the image capturing panel, power supply section and storage section integrated into one unit. This structure ensures simple capturing of a radiographic image.

Image capturing panel 21 of radiographic image detector 5 described with reference to FIGS. 3 and 4 may be designed in a different structure. For example, FIG. 16 (B) of the Official Gazette of Japanese Patent Tokkaihei 9-294229, or FIG. 4 (B) of the Official Gazette of Japanese Patent Tokkai 2004-6781 and the Official Gazette of Japanese Patent Tokkai 2000-61823 may be utilized.

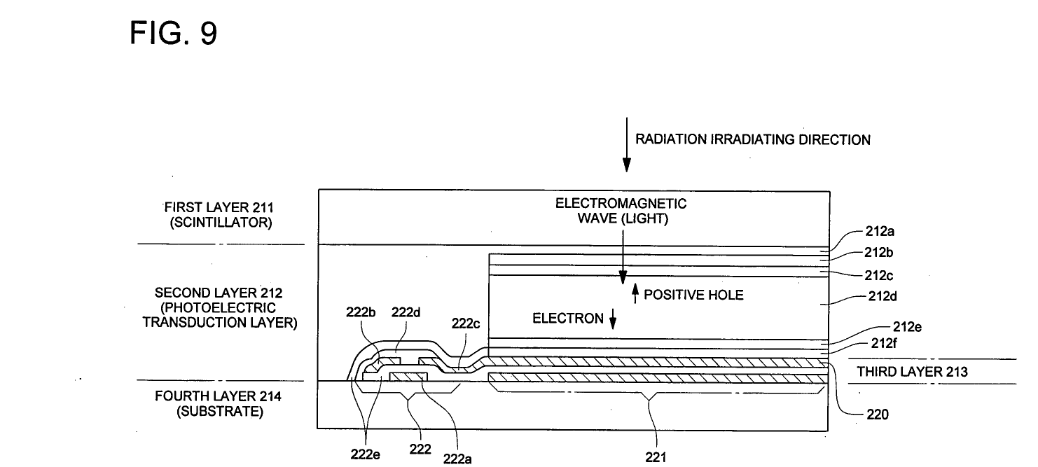

The aforementioned image capturing panel 21 of FIGS. 3 and 4 represents a photoelectric transduction element made of inorganic substance. The photoelectric transduction element can be made of organic substance. The image capturing panel of such a structure will be described with reference to the examples of the structure disclosed by the present inventors together with other inventors in the Official Gazette of Japanese Patent Tokkai 2003-344545. FIG. 9 is a diagram representing the circuit configuration of a radiographic image detector composed of the image capturing panel containing the photoelectric transduction element made of organic substance. FIG. 10 is a cross sectional view partially showing the interior of image capturing panel of FIG. 9.

As shown in FIG. 9, in image capturing panel 21, collection electrode 220 for reading the electric energy stored in response to the intensity of the applied radial ray is arranged in 2D form. Collection electrode 220 is assumed as one of the electrodes of capacitor 221, and electric energy is stored in capacitor 221. One collection electrode 220 corresponds to one pixel of the radiographic image.

Between pixels, there are arranged reading lines 223-1 to 223-m and signal lines 224-1 to 224-n so that they may cross at right angles. To capacitor 221-(1, 1), there is connected transistor 222-(1, 1) which is structured in the way of a silicone layer upon layer structure or structured with organic semiconductors. This transistor 222-(1, 1) is, for example, a field effect transistor, and a drain electrode or a source electrode is connected with collecting electrode 220-(1, 1), while, a gate electrode is connected to reading line 223-1. When the drain electrode is connected to collecting electrode 220-(1, 1), the source electrode is connected to signal line 224-1, and when the source electrode is connected to collecting electrode 220-(1, 1), the drain electrode is connected to signal line 224-1. Further, for collecting electrode 220, capacitor 221 and transistor 222 of another pixel, reading line 223 and signal line 224 are connected in the same way.

FIG. 10 shows a partial section of image capturing panel 21, and on the side where radiation is irradiated, there is provided a first layer 211 as a scintillation layer that emits light according to intensity of radiation that enters. In this case, the first layer 211 is irradiated by the so-called X-ray (radiation) representing an electromagnetic wave which has a wavelength of about 1 angstrom (1×10⁻¹⁰ m) and is transmitted through a human body. This X-ray is irradiated from radiation source 10 of FIG. 1.

The first layer 211 is mainly composed of phosphor and outputs electromagnetic waves of wavelengths in a range of 300 nm to 800 nm, that is, electromagnetic waves (light) from ultraviolet light to infrared light including visible light between them, based on the entering radiation. The phosphor utilized in the first layer 211 is composed of tungstate phosphor, a terbium activated rare earth sulfide phosphor, a terbium activated rare earth phosphate phosphor, a terbium activated rare earth oxyhalide phosphor or cesium iodide, however it is not limited to these and may be a phosphor outputting, by irradiation of radiation, electromagnetic waves of a range in which the light receiving element has its sensitivity, such as a visible, an ultraviolet or an infrared range.

Next, on the side opposite to the radiation-irradiated side of the first layer 211, there is formed second layer 212 which converts electromagnetic wave (light) outputted from the first layer into electric energy. The second layer 212 is provided with diaphragm 212a, transparent electrode membrane. 212b, electron hole conducting layer 212c, charge generating layer 212d, electron conducting layer 212e and conductive layer 212f which are arranged in this order from the first layer 211 side. In this case, the charge generating layer 212d is one containing organic compounds which can conduct photoelectric transduction, namely, the organic compounds which can generate an electron and an electron hole with electromagnetic waves, and it is preferable, for smooth photoelectric transduction, that the charge generating layer 212d has some layers each having a separated function. For example, the second layer is constituted as shown in FIG. 10.

The diaphragm 212a is one for separating the first layer 211 from other layers, and oxi-nitride, for example, is used for the diaphragm. The transparent electrode membrane 212b is formed by using conductive transparent material such as, for example, indium tin oxide (ITO), SnO₂ and ZnO. When forming the transparent electrode membrane 212b, a thin membrane is formed by using a method of evaporation or of sputtering. Further, it is also possible to form a pattern having a desired form by a method of photolithography, or to form a pattern through a mask having a desired form in the course of evaporation or sputtering of the material for electrode stated above, when high accuracy is not necessary for the pattern (100 μm or more).

On charge generating layer 212d, electrons and electron holes are generated by the electromagnetic wave (light) outputted from the first layer 211. The electron holes generated here are collected to the electron hole conducting layer 212c, while, the electrons are collected to the electron conducting layer 212e. Incidentally, the electron hole conducting layer 212c and the electron conducting layer 212e are not always indispensable.

The conductive layer 212f is made of chromium, for example. It can be selected from an ordinary metal electrode or from the transparent electrode mentioned above. However, for obtaining excellent characteristics, the one whose material for electrode is a metal having a small work function (4.5 eV or less), alloy, conductive compound or mixture thereof is preferable. As a concrete example of the material for the electrode, there are given sodium, sodium-potassium alloy, magnesium, lithium, aluminum, however it is not limited to them. The conductive layer 212f can be made through a method of evaporation or sputtering by using the above-mentioned materials for electrode.

Next, charge generating layer 212d, is composed of cyanine dye association or organic compound forming J aggregate. The cyanine dye is well known as a spectral sensitizer for silver halide photography. J aggregate absorbs visible light and electrons composing the dye molecules become excited electrons, which transfer into silver halide grains to make the silver halide grains to be exposed to light. The cyanine dye is generally known to form dye molecule association on the silver halide grains. The dye molecules become stable itself by forming the association.

On the side opposite to the radiation-irradiated side on the second layer 212, there is formed third layer 213 which outputs signals based on accumulation of electric energy obtained by the second layer 212 and on accumulated electric energy. The third layer 213 is composed of capacitor 221 which stores, for each pixel, electric energy generated by the second layer 212 and transistor 222 representing a switching element for outputting accumulated electric energy as signals. Incidentally, the third layer is not limited to one employing a switching element, but it can also be of a structure to generate and output signals according to the energy level of the accumulated electric energy, for example.

TFT (thin-film transistor), for example, is used for the transistor 222. The TFT may be either one of an inorganic semiconductor type used for a liquid crystal display or one employing an organic semiconductor, and a preferable one is TFT formed on a plastic film. As TFT formed on a plastic film, there is known one that is of an amorphous silicone type.

To transistor 222 representing a switching element, there is connected collecting electrode 220 that stores electric energy generated by the second layer 212 as shown in FIGS. 9 and 10 and serves as an electrode on one side of capacitor 221. In the capacitor 221, there is accumulated electric energy generated by the second layer 212, and this accumulated electric energy is read out when transistor 222 is driven. Namely, by driving the switching element, it is possible to generate a signal for each pixel for radiation images. Incidentally, in FIG. 10, the transistor 222 is composed of gate electrode 222a, source electrode (drain electrode) 222b, drain electrode (source electrode) 222c, organic semiconductor layer 222d and insulating layer 222e.

Fourth layer 214 is a substrate of image capturing panel 21. A substrate used preferably as the fourth layer 214 is a plastic film which includes films made of polyethylene terephthalate (PET), polyethylene naphthalate PEN), polyether sulfone (PES), polyether imido, polyether etherketone, polyphenylene sulfido, polyallylate, polyimido, polycarbonate (PC), cellulose triacetate (TAC) and cellulose acetate propionate (CAP). By using a plastic film as stated above, it is possible to attain light weight and to improve durability for impact, compared with an occasion of using a glass substrate.

On the side opposite to the third layer side on the fourth layer 214, there may also be provided power supply section 34 such as, for example, a primary cell such as a manganese battery, a nickel cadmium battery, a mercury battery or a lead battery, or a secondary cell of a charging type. As a shape of the battery, a flat plate shape is preferable so that a radiation image detector can be made to be of a thin type.

Further, on image capturing panel 21, there are provided transistors 232-1 to 232-n for initializing wherein a drain electrode, for example, is connected to signal lines 224-1 to 224-n. A source electrode of the transistors 232-1 to 232-n is grounded. Further, a gate electrode is connected to reset line 231.

Reading lines 223-1 to 223-m of image capturing panel 21 and reset line 231 are connected with reading drive circuit 25 as shown in FIG. 9. When reading signal RS is supplied from the reading drive circuit 25 to one reading line 223-p (p represents a value of either one of 1 to m) out of reading lines 223-1 to 223-m, transistors 222-(p,1) to 222-(p,n) which are connected to this reading line 223-p, are turned on, and electric energy accumulated in capacitors 221-(p,1) to 221-(p,n) are read out to signal lines 224-1 to 224-n. Signal lines 224-1 to 224-n are connected to signal converters 271-1 to 271-n of signal selecting circuit 27, and signal converters 271-1 to 271-n generate voltage signals SV-1-SV-n which are proportional to electric energy read out on signal lines 224-1 to 224-n. The voltage signals SV-1-SV-n outputted from the signal converters 271-1 to 271-n are supplied to register 272.

In the register 272, voltage signals thus supplied are selected in succession to be converted into digital image signal for one reading line by A/D converter 273 (for example, 12 bit to 14 bit), while, control circuit 30 supplies read signal RS to each of reading lines 223-1 to 223-m through reading drive circuit to conduct image reading, and takes in digital-image signal for each reading line to generate image signals for a radiation image. The image signals are supplied to control circuit 30.

Incidentally, when transistors 232-1 to 232-n are turned on by supplying reset signal RT to reset line 231 from reading drive circuit 25, and transistors 222-(1,1) to 222-(m,n) are turned on by supplying read signal RS to reading lines 223-1 to 223-m, electric energy stored in capacitors 221-(1,1) to 221-(m,n) are discharged through transistors 232-1-232-n, and thereby, initialization of image capturing panel 21 can be carried out.

As shown in FIG. 9, control circuit 30 is connected with memory 31, operation section 32, display section 33 and communication section 35. The operation of radiographic image detector 5 is controlled according to the operation signal PS from operation section 32 and radio signal “n” from controlling apparatus 1.

Operation section 32 is provided with a plurality of switches. Initialization of image capturing panel 21 and generation of the radiographic image signal are carried out according to operation signal PS in response to the switching operation from operation section 32 or the radio signal “n” from the controlling apparatus 1. The storage capacity of memory 31 is sufficient to store a plurality of pieces of image data.

Control circuit 30 provides processing of allowing the generated image signal to be stored in memory 31. It also transfers the data radio signal “m” by radio from detector communication section 35 to the PC communication section 4 shown in FIGS. 1 and 5.

Further, when the detector communication section 35 receives irradiation ready signal from the radiation generation control apparatus 102, the control circuit 30 conducts an initializing (reset) action for the image capturing panel 21. Also, when receiving irradiation signal, the control circuit 30 conducts producing image signals of a radiation image and image data are read out. Further, when the initialization of the image capturing panel 21 has been completed, the detector communication section 35 sends a reset action completion signal as a radio signal r.

As described above, similarly to the case of FIGS. 3 and 4, radiographic image detector 5 shown in FIGS. 2, 9 and 10 is designed in a portable flat panel structure with the image capturing panel, power supply section and storage section integrated into one unit. This structure ensures simple capturing of a radiographic image.

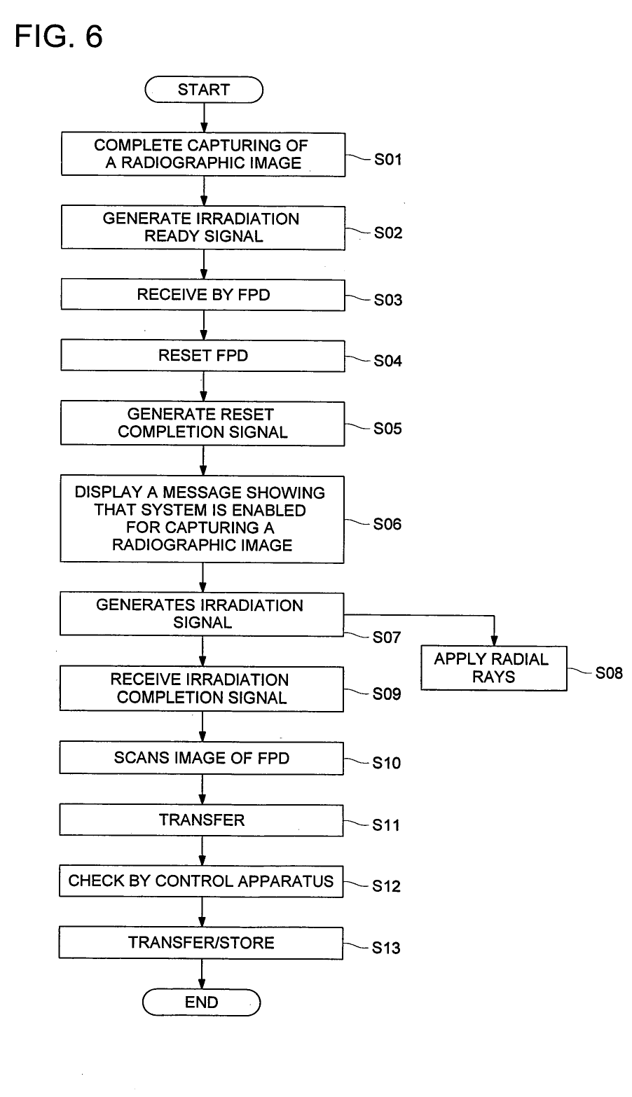

Referring the flowchart of FIG. 6, the following describes the Steps S01 through S12 of the radiographic image capturing method in the aforementioned radiographic image capturing system.

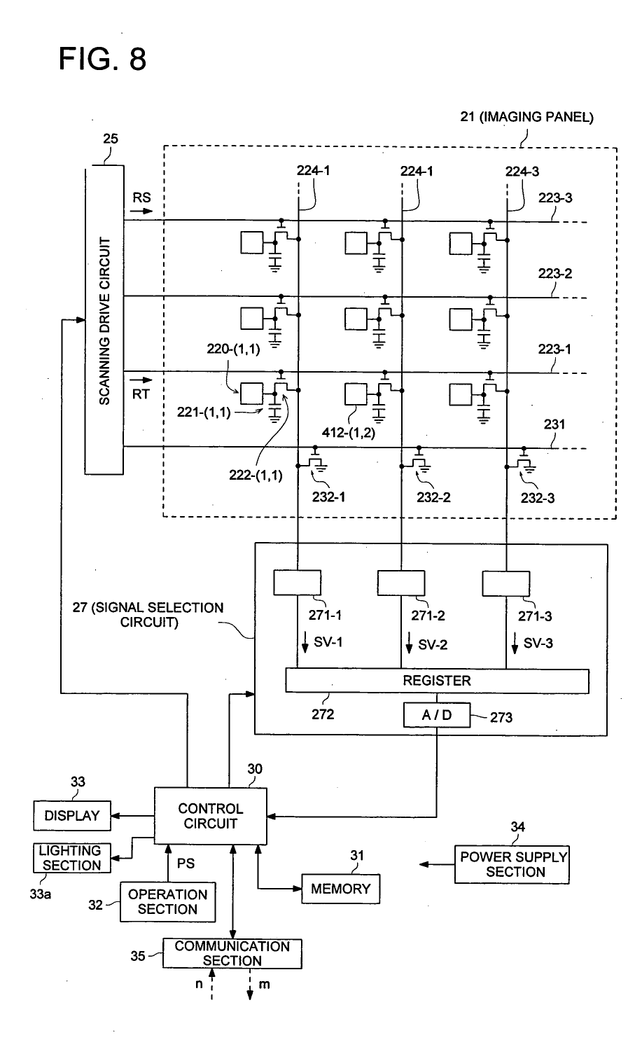

A patient P as a subject is located in the lying position as shown in FIG. 1. A flat panel detector (FPD) 5 is positioned between the bed 110 and the patient P. Upon completion of preparation work for capturing a radiographic image (Step S01), a radiologist depress the irradiation button 102a of the radiation generation control apparatus 102 of the FIG. 1 in the downward direction v in the first stage. Then an irradiation ready signal occurs (Step S02). It is sent to the FPD 5 by radio from the radiation generation control apparatus 102, and is received as a radiographic image capturing start signal by the FPD 5 (Step S03). The FPD 5 supplies the reset signal RT to the reset line 231 from the reading drive circuit 25 of FIG. 8, whereby the image capturing panel 21 is reset (initialized) (Step S04).

Upon completion of the aforementioned Step S04, a reset completion signal is issued from the FPD 5 (Step S05), and the reset completion signal is sent to the radiation generation control apparatus 102 by radio. When the signal has been received by the radiation generation control apparatus 102, a message appears on the display section 102c to indicate the system is enabled to capture a radiographic image (Step S06).

Based on the message appearing on the display section 102c indicating the system is enabled to capture a radiographic image, the radiologist depresses the irradiation button 102a in the further downward direction v in the second stage, and an irradiation signal is issued from the radiation generation control apparatus 102 (Step S07). Then the radial ray 100 is applied to the patient P of FIG. 1 from the radiation source 101 (Step S08). In this case, the radial rays having passed through the patient P is applied to the image capturing panel 21 of the FPD 5 of FIGS. 2, 8 and 9, and the electrical charge is stored as electric energy into the capacitor 221, in response to the intensity of the applied radial rays applied to the image capturing panel 21.

When the FPD 5 has received the irradiation completion signal from the radiation generation control apparatus 102 (Step S09), the FPD 5 starts reading the radiographic image (Step S10). The control circuit 30 of the FPD 5 of FIG. 8 supplies the readout signal RS to each of the reading lines 223-1 through 223-m through the reading drive circuit 25, whereby reading is performed. The digital image signal, for each of the reading lines, converted into the digital signal by the analog-to-digital converter 273 is captured to generate the image signal of the radiographic image. The generated radiographic image data is stored in the storage section 31. In this case, after reading the radiographic image, the FPD 5 deletes the image data.

The FPD 5 sends the radiographic image data stored in the storage section 31 as the data radio signal m, from the detector communication section 35 to the control apparatus 1 (Step S11). When the control apparatus 1 has received the radiographic image data, the image is checked, and a predetermined image processing is applied by the image processing section 7 (Step S12). As shown in FIG. 5, the image data is transferred to the image display apparatus 51, database server 52 and printer 53 from the output section 8 via the network 50, and is stored into the database server 52 (Step S13).

According to this radiographic image capturing method in the radiographic image capturing system of FIG. 6, the irradiation ready signal is sent to the FPD 5 by radio from the radiation generation control apparatus 102 upon completion of the preparation work for capturing a radiographic image. According to the irradiation ready signal having been received, the FPD 5 performs the reset operation. This arrangement allows the FPD 5 to be reset immediately before irradiation. At the same time, upon completion of the FPD 5 resetting, the reset completion signal is sent to the radiation generation control apparatus 102 from the FPD 5 by radio, and a message appears on the display section 102c to show that the system is enabled to capture a radiographic image. Then an irradiation signal is generated. Generation of the irradiation signal allows a radiographic image to be captured, and the FPD 5 having received the irradiation signal immediately scans the radiographic image. Accordingly, it allows the FPD 5 to scan the radiographic image before the electric energy accumulated subsequent to application of radial rays is reduced by leakage of electrical charge or other reasons.

In FIG. 6, the irradiation button 102a in the first stage is depressed and the irradiation ready signal having been-generated is received by the FPD 5. Then the FPD 5 resets the image capturing panel 21 in Step S04. In this case, it is also possible to make the following arrangements: When a radiologist depresses the irradiation button 102a in the second stage, regardless of the message showing that the system is ready for capturing a radiographic image, in the Step S06, the irradiation signal is sent to the FPD 5. After the resetting of the FPD 5, the reset signal is sent to the radiation generation control apparatus 102, and the radiation generation control apparatus 102 applies the X-ray upon receipt of the reset completion signal.

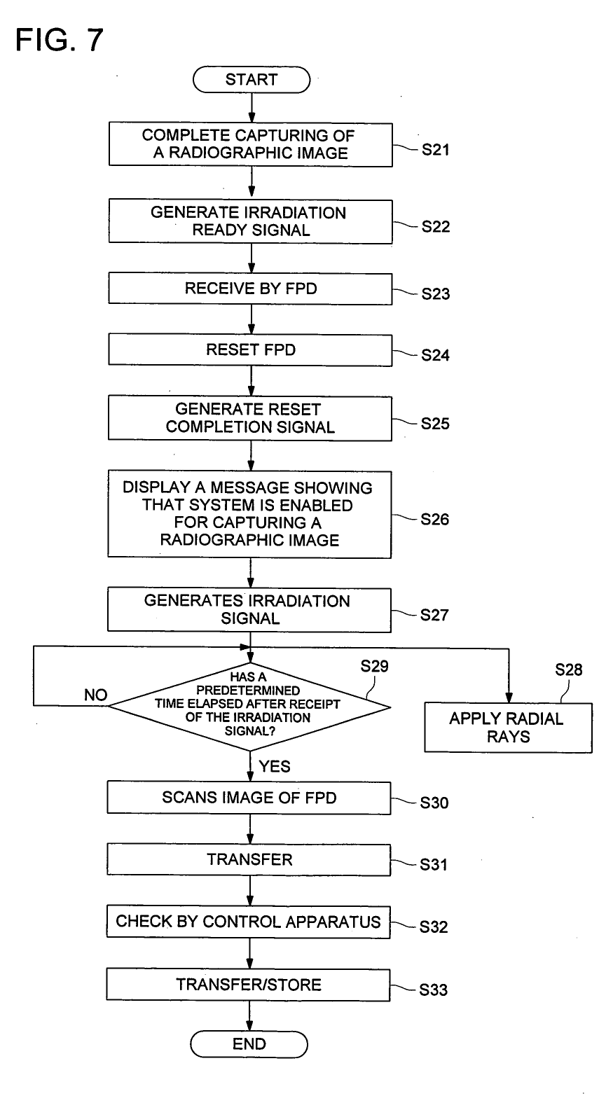

Referring to the flowchart given in FIG. 7, the following describes the Steps S21 through S33 in the radiographic image capturing method of the radiographic image capturing system:

Steps S21 through S27 in FIG. 7 correspond to Steps S01 through S08 in FIG. 6, and will not be described to avoid duplication. When the irradiation signal is sent from the radiation generation control apparatus 102 (S27), the radial ray 100 is applied to the patient P of FIG. 1 (S28). On the other hand, the control section 30 measures the duration of time elapsed after the FPD 5 receives the irradiation signal having occurred in the Steps S22, and a decision is made to see whether or not a predetermined time has elapsed (Step S29). When a predetermined time has elapsed, the FPD 5 starts reading the radiographic image (Step S30).

After that, similarly to the case of Steps S11 through S13, the radiographic image data scanned and generated is transferred as the data radio signal m from the FPD 5 to the control apparatus 1 (Step S31), which checks the image and applies predetermined processing (Step S32). The image data is transferred to the image display apparatus 51, database server 52 and printer 53 in the consultation room via the network 50, and is stored into the database server 52 (Step S33).

According to the radiographic image capturing method in the radiographic image capturing system shown in FIG. 7, upon completion of preparation work for capturing a radiographic image, the irradiation ready signal is sent to the FPD 5 by radio from the radiation generation control apparatus 102. Then, the FPD 5 performs a reset operation based on the irradiation ready signal having been received. This arrangement allows the FPD 5 to be reset immediately before radiation exposure. Upon completion of the reset operation, a reset completion signal is sent from the FPD 5 by radio, and a message is displayed on the display section 102c to show that the system is enabled to capture a radiographic image. Then an irradiation signal is generated. Generation of the irradiation signal allows a radiographic image to be captured. The FPD 5 starts reading the radiographic image after the lapse of a predetermined time upon receipt of the irradiation ready signal. This permits the FPD 5 to scan the radiographic image immediately after capturing a radiographic image. Thus, the FPD 5 is permitted to scan the radiographic image before the electric energy accumulated subsequent to application of radial rays is reduced by leakage of electrical charge or other reasons.

The best form of embodiments of the present invention has been described. It is to be expressly understood, however, that the present invention is not restricted thereto. The present invention can be embodied in a great number of variations with appropriate modification or additions, without departing from the technological spirit and scope of the invention claimed. For example, the radiographic image detector 5 shown in FIGS. 2 through 4 converts radial rays into light using a phosphor such as a scintillator. This light is scanned by the optical detector, whereby radiographic image data is generated, according to this indirect conversion type. Without being restricted thereto, the present invention can be a direct conversion type wherein the radial rays are directly chanted into electric charges, which are scanned by a capacity or the like; thus radiographic image data is generated.

In FIGS. 1 and 5, radio communication is directly carried out between the radiation generation control apparatus 102 and radiographic image detector 5. It can be carried out through the control apparatus 1. To be more specific, the radio signal from the radiation generation control apparatus 102 and radiographic image detector 5 is sent to the control apparatus 1, which then sends the signal to the radiographic image detector 5 or radiation generation control apparatus 102. In this case, radio waves may be used for communication between the radiation generation control apparatus 102 and radiographic image detector 5. As shown in FIGS. 1 and 5, the connection cable 102e may also be used for communication. It is also possible to make such arrangements that the control section 6 measures the duration of time elapsed after receipt of the irradiation ready signal generated in Step S22 and a decision is made to see if a predetermined time has elapsed or not.

What is claimed is:

1. A radiographing system for radiographing an object, comprising:
(1) a radiation generator to irradiate radiation to an object, and
(2) a radiographic image detector to detect a radiographic image of the object,
wherein each of the radiation generator and the radiographic image detector comprises a respective radio section to transmit and receive information as radio signals, and
wherein when radiographing the object, the radiation generator transmits irradiating information by a radio signal to the radiographic image detector, and then the radiographic image detector reads a radiographic image on a basis of the received the irradiating information.

2. The radiographing system of claim 1, wherein the irradiating information includes irradiating timing information.

3. The radiographing system of claim 2, wherein the irradiating timing information includes an irradiation ready signal, and when the radiographic image detector receives the irradiation ready signal, the radiographic-image detector conduct a reset action for a detector.

4. The radiographing system of claim 3, wherein when the reset action has been completed, the radiographic image detector transmits a reset completion signal to the radiation generator, then when the radiation generator receives the reset completion signal, the radiation generator indicates a radiography possible condition.

5. The radiographing system of claim 3, wherein when the reset action has been completed, the radiographic image detector transmits a reset completion signal to the radiation generator, then when the radiation generator receives the reset completion signal, the radiation generator transmits an irradiation start signal to the radiographic image detector and irradiates radiation to the object.

6. The radiographing system of claim 5, wherein the radiographic image detector starts reading a radiographic image at a predetermined time after receiving the irradiation start signal.

7. The radiographing system of claim 1, wherein the radiation generator comprises a two stage type irradiation button to generate two kinds of irradiation timing information, and when the irradiation button is pressed, the radiation generator issues an irradiation ready signal at a first stage and then issues an irradiation signal at a second stage.

8. The radiographing system of claim 1, further comprising:
a control device having a radio section, an image processing section, a memory section and an image displaying section,
wherein the control section receives the read-out radiographic image data at the radio section, conducts an image processing for the received radiographic image data, and stores the processed radiographic image data at the memory section or indicates the processed radiographic image data at the displaying section.

9. The radiographing system of claim 8, wherein the radiation generation and the radiographic image detector are controlled by a radio signal through the respective radio sections by the control device.
